(19) United States
(12) Patent Application Publication
(10) Pub. No.: US 2011/0066426 A1
(43) Pub. Date: Mar. 17, 2011

(54) REAL-TIME SPEAKER-ADAPTIVE SPEECH RECOGNITION APPARATUS AND METHOD

(75) Inventor: Gil Ho LEE, Hwaseong-si (KR)

(73) Assignee: SAMSUNG ELECTRONICS CO., LTD., Suwon-si (KR)

(21) Appl. No.: 12/836,971

(22) Filed: Jul. 15, 2010

(30) Foreign Application Priority Data
Sep. 11, 2009 (KR) 10-2009-0086024

(51) Int. Cl. G10L 15/00; G10L 11/04

(52) U.S. Cl. 704/207; 704/246; 704/E15.001; 704/E11.006

(57) ABSTRACT

A speech recognition apparatus and method for real-time speaker adaptation are provided. The speech recognition apparatus may estimate a pitch of a speech section from an inputted speech signal, extract a speech feature for speech recognition based on the estimated pitch, and perform speech recognition with respect to the speech signal based on the speech feature. The speech recognition apparatus may be adaptively normalized depending on a speaker. Thus, the speech recognition apparatus may extract a speech feature for speech recognition, and may improve a performance of speech recognition based on the extracted speech feature.

### CROSS-REFERENCE TO RELATED APPLICATION(S)

This application claims the benefit under 35 U.S.C. §119(a) of Korean Patent Application No. 10-2009-0086024, filed Sep. 11, 2009, in the Korean Intellectual Property Office, the entire disclosure of which is incorporated herein by reference for all purposes.

### BACKGROUND

1. Field

The following description relates to a speech recognition apparatus and method, and more particularly, to a speech recognition apparatus and method for improving speech recognition performance.

2. Description of the Related Art

In general, speech recognition may be classified into a speaker dependent system and a speaker independent system. In the example of the speaker dependent system, the system only recognizes a predetermined speaker. In the example of the speaker independent system, the system may perform recognition regardless of a speaker.

For example, the speaker dependent speech recognition system may store and register the speech of a user. The system may perform speech recognition by comparing inputted speech of a user with a pattern of speech previously stored for that user.

The speaker independent speech recognition system may recognize speech of a plurality of unspecified speakers by collecting speech of speakers, learning a statistical model, performing recognition using the learned model, and the like.

In a conventional art, available normalization factors may be applied to an acoustic model to perform speech recognition. A method may recognize the inputted speech based on the normalization factors. However, because the method may require a relatively large number of operations, a plurality of speech recognitions may not be simultaneously performed. Also, the method may be unsuitable for a real-time speech recognition system or terminal-type speech recognition system, because the time to process the relatively large number of operations may require too much time.

### SUMMARY

In one general aspect, there is provided a speech recognition apparatus, comprising a pitch estimation unit configured to extract a speech section from a speech signal and to estimate a pitch of the speech section, a speech feature extraction unit configured to extract a speech feature for speech recognition from the speech section based on the estimated pitch, and a speech recognition unit configured to perform speech recognition with respect to the speech signal based on the extracted speech feature.

The pitch estimation unit may comprise a speech section extraction unit configured to extract the speech section that includes a starting point and an ending point of the speech section, and a voice determination unit configured to determine whether the speech section is a voice frame or an unvoiced frame.

The pitch estimation unit may further be configured to estimate the pitch of the speech section when the speech section is the voice frame, and replace the pitch of the speech section with a pitch of one or more previous voice frames when the speech section is an unvoiced frame.

The speech feature extraction unit may comprise a warping factor calculation unit configured to calculate a warping factor for vocal tract length normalization based on the estimated pitch, and a frequency warping unit configured to perform frequency warping based on the warping factor, wherein the speech recognition unit is further configured to perform speech recognition based on the frequency-warped speech feature.

The speech feature extraction unit may further comprise a preprocessing unit configured to perform pre-processing to emphasize a high frequency band of the speech signal, and a window processing unit configured to process a Hamming window with respect to the pre-processed speech signal, wherein the warping factor calculation unit is further configured to calculate the warping factor with respect to the speech signal where the Hamming window is processed.

The speech recognition apparatus may further comprise a user feedback unit configured to perform user feedback with respect to the speech recognition.

The warping factor calculation unit may further be configured to calculate the warping factor based on the user feedback.

The user feedback may comprise information about at least one of the pitch, the warping factor, and a speech recognition rate.

In another aspect, there is provided a speech recognition method, comprising extracting a speech section from a speech signal and estimating a pitch of the speech section, extracting a speech feature for speech recognition in the speech section based on the estimated pitch, and performing speech recognition with respect to the speech signal based on the extracted speech feature.

The speech recognition method may further comprise performing user feedback with respect to the speech recognition to increase an accuracy of a warping factor.

In another aspect, there is provided a voice recognition apparatus, comprising a pitch estimation unit configured to detect a pitch of a voice frame generated by a voice, a voice feature extraction unit configured to extract a voice feature from the detected pitch of the voice frame, and a voice recognition unit configured to perform voice recognition from the extracted voice feature.

The pitch estimation unit may comprise a voice frame extraction unit configured to extract, from the voice a starting point and an ending point of the voice frame, and a voice determination unit configured to determine whether the speech section is a voice frame or an unvoiced frame.

If the voice frame is an unvoiced frame, the pitch estimation unit may further be configured to replace the pitch of the unvoiced frame with a pitch of one or more previous voice frames.

The voice feature extraction unit may comprise a warping factor calculation unit configured to calculate a warping factor for vocal tract length normalization based on the detected pitch, and a frequency warping unit configured to perform frequency warping based on the warping factor, wherein the voice recognition unit is further configured to perform voice recognition based on the frequency-warped speech feature.

The voice frame may include at least one of: a spoken word, a spoken sentence, and a spoken utterance.

Other features and aspects may be apparent from the following description, the drawings, and the claims.

### BRIEF DESCRIPTION OF THE DRAWINGS

FIG. 1 is a diagram illustrating an operation of an example speech recognition apparatus.

FIG. 2 is a diagram illustrating an example of a speech recognition apparatus.

FIG. 3 is a diagram illustrating an example of a pitch estimation unit and an example of a speech feature extraction unit, illustrated in FIG. 2.

FIG. 4 is a graph illustrating an example of a pitch distribution of an inputted speech signal.

FIG. 5 is a graph illustrating an example of warping factors of a pitch estimation method and a Maximum Likelihood (ML) method.

FIG. 6 is a graph illustrating an example of pitch estimation for 200 utterances.

FIG. 7 is a flowchart illustrating an example of a speech recognition method.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

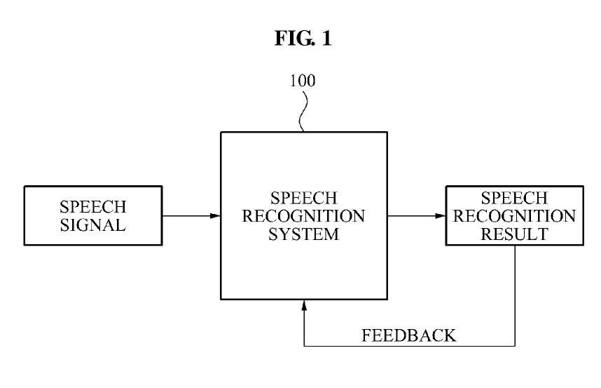

FIG. 1 illustrates an operation of an example speech recognition apparatus.

Referring to FIG. 1, speech recognition apparatus 100 may extract a speech feature of a speaker from an inputted speech signal, perform speech recognition based on the speech feature, and improve the performance of speech recognition. The speech recognition apparatus 100 may perform speaker-adaptive speech recognition in real time. The speech recognition apparatus 100, may be included in a terminal, such as a personal computer, a wireless telephone, and personal digital assistant, and the like.

For example, the speech recognition apparatus 100 may estimate a pitch of speech from a speech signal, calculate a vocal tract length normalization factor using the pitch, and extract a speech feature. Accordingly, the speech recognition apparatus 100 may perform speech recognition using the speech feature. Also, the speech recognition apparatus 100 may receive a feedback of the speech recognition result from a user. Thus, a more accurate normalization factor may be calculated, and the performance of speech recognition may be improved. As described herein, a speech feature or a voice feature may refer to at least one of a spoken word, a spoken sentence, a spoken utterance, and the like, that is spoken by a person.

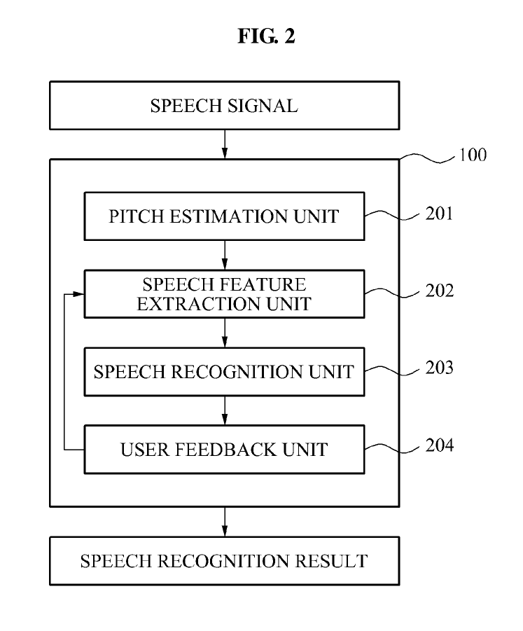

FIG. 2 illustrates an example of a speech recognition apparatus.

Referring to FIG. 2, the speech recognition apparatus 100 includes a pitch estimation unit 201, a speech feature extraction unit 202, and a speech recognition unit 203. In some embodiments, the speech recognition apparatus 100 may further include a user feedback unit 204.

The pitch estimation unit 201 may extract a section of speech from a speech signal and estimate or detect a pitch of the speech section. The pitch may indicate a natural frequency of a sound. Pitch is a subjective sensation in which a listener assigns perceived tones to relative positions on a musical scale based primarily on the frequency of vibration generated by a user's vocal cords.

The speech feature extraction unit 202 may extract a speech feature from the speech section based on the estimated pitch. Accordingly, the speech feature may be used for speech recognition. In some embodiments, the speech feature extraction unit 202 may be referred to as a voice feature extraction unit.

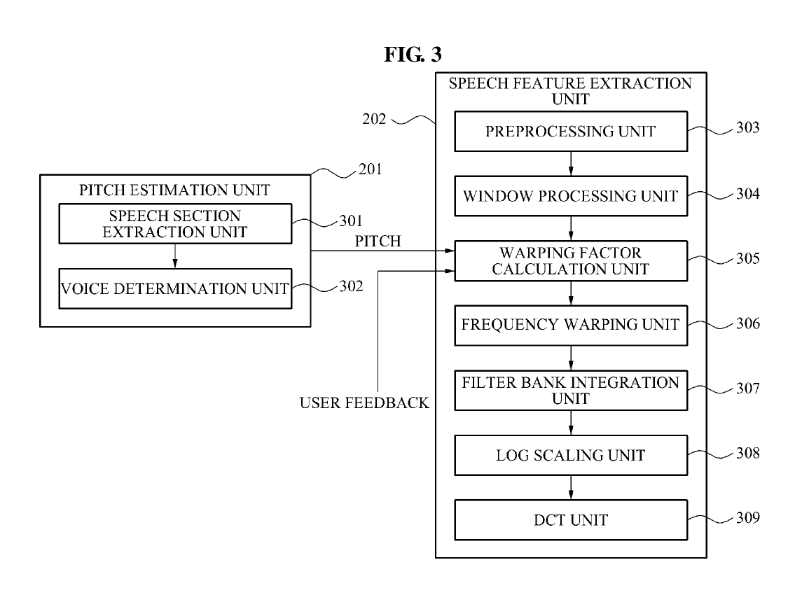

The pitch estimation unit 201 and the speech feature extraction unit 202 are further described with reference to FIG. 3.

The speech recognition unit 203 may perform speech recognition with respect to the speech signal based on the extracted speech feature. In some embodiments, the speech recognition unit 203 may be referred to as a voice feature extraction unit.

The user feedback unit 204 may perform user feedback with respect to the speech recognition, and transmit a result of the user feedback to the speech feature extraction unit 202. Accordingly, speech recognition performance may be improved by repeated feedback.

As used herein, the term speech may refer to a voice of a user. For example, the voice may include spoken words, sounds, and other utterances.

FIG. 3 illustrates an example of a pitch estimation unit and an example of a speech feature extraction unit, illustrated in FIG. 2.

Referring to FIG. 3, the pitch estimation unit 201 includes a speech section extraction unit 301 and a voice determination unit 302.

The speech section extraction unit 301 may extract the speech section including a starting point and an ending point of the speech section from the inputted speech signal.

The speech signal may be inputted from, for example, a microphone and the like. When the speech signal does not include a speech section, the speech section extraction operation may be omitted. In some embodiments, the speech section extraction unit 301 may be referred to as a voice frame extraction unit.

The voice determination unit 302 may determine whether the speech section is a voice frame. For example, the voice determination unit 302 may ascertain the reliability of the estimated pitch, and may determine whether the speech section is a voice frame or an unvoiced frame.

In this example, when the speech section is a voice frame, the pitch estimation unit 201 may estimate a pitch of the speech section. Conversely, when the speech section is an unvoiced frame, the pitch estimation unit 201 may replace the pitch of the unvoiced frame with the pitch of one or more previous voice frames. For example, the pitch from a plurality of previous voice frames may be normalized or averaged to generate a replacement pitch value, and this replacement pitch value may be added to the unvoiced frame. In this example, the term voice indicates a sound generated due to vibration of a user's vocal cords, and the term unvoice indicates a sound generated without the vibration of user's vocal cords.

The pitch that is estimated by the pitch estimation unit 201, may be transmitted to the speech feature extraction unit 202. Also, the user feedback with respect to the speech recognition may be transmitted to the speech feature extraction unit 202.

Referring to FIG. 3, the speech feature extraction unit 202 includes a preprocessing unit 303, a window processing unit 304, a warping factor calculation unit 305, and a frequency warping unit 306. In some embodiments, the speech feature extraction unit 202 may further include one or more of a filter bank integration unit 307, a log scaling unit 308, and/or a Discrete Cosine Transform (DCT) unit 309.

The preprocessing unit 303 may perform pre-processing to emphasize a frequency band of the speech signal. For example, the preprocessing unit 303 may perform pre-processing according to Equation 1 as shown below.

sₚᵣₑ(n)=sᵢₙ(n)−0.97sᵢₙ(n−1) [Equation 1]

In Equation 1, Sₚᵣₑ refers to a pre-processed input signal, and Sᵢₙ refers to an input signal. It should be noted that Equation 1 is merely for purposes of example, and may vary depending on the configuration of a system.

The window processing unit 304 may process a Hamming window with respect to the pre-processed speech signal. For example, the window processing unit 304 may process the Hamming window with respect to the pre-processed speech signal according to Equation 2 as shown below.

$${W}_{hamm} ( n ) = \{ 0.54 - 0.46 cos ( \frac{2 π n}{N} ) \} , n = 0 , … , N \qquad [ Equation 2 ]$$

It should be noted that Equation 2 is merely for purposes of example, and may vary depending on the configuration of a system.

The warping factor calculation unit 305 may calculate a warping factor for vocal tract length normalization based on the estimated pitch. For example, the warping factor calculation unit 305 may calculate the warping factor with respect to the speech signal where the Hamming window is processed. In this example, the vocal tract length normalization may indicate a method of warping a speech signal to enable vocal tract lengths that vary depending on a speaker, to be suitable for a standard speaker. As described herein, warping refers to distorting a speech signal, for example, distorting a speech signal of a speaker to be similar to a reference speech signal. By distorting inputted speech signals, speech signals inputted from different users, having different pitches, may be warped to a standard level, and may be compared with each other. For example, the warping factor calculation unit 305 may calculate the warping factor according to Equation 3 as shown below.

WFactor=1+α(pitch−μ), α=0.002, μ=203.777 [Equation 3]

In Equation 3, the term “WFactor” refers to the warping factor, and may have a value from 0.8 to 1.4.

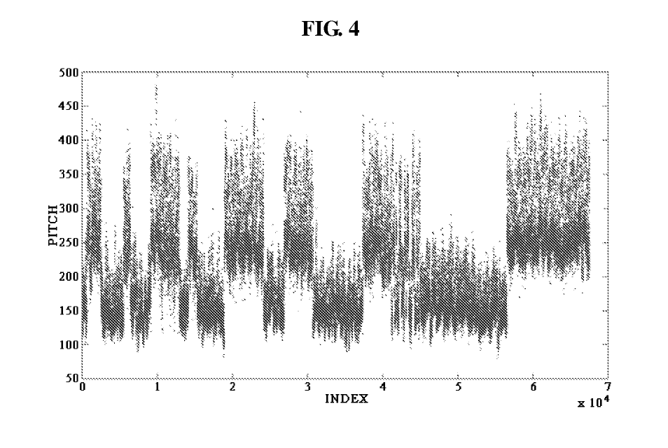

FIG. 4 is a graph that illustrates an example of a pitch distribution of an inputted speech signal. Referring to the example shown in FIG. 4, the pitch may be distributed in a range, for example, in a range of approximately 100 to approximately 400. In this example, the average value of the pitch is 203.777. Also, in this example α refers to a speech recognition rate. Equation 3 is an example of a linear relationship between the warping factor and the pitch, and may be changed to at least one quadratic equation based on the configuration of the system.

The user feedback unit 204 may perform user feedback with respect to the speech recognition to improve the accuracy of the warping factor. The warping factor calculation unit 305 may calculate the warping factor based on the user feedback. For example, the user feedback may include information about at least one of the pitch, the warping factor, a speech recognition rate, and the like.

The frequency warping unit 306 may perform frequency warping based on the warping factor. For example, the frequency warping unit 306 may perform frequency analysis with respect to the speech signal, and may perform frequency warping based on the warping factor when the frequency analysis is performed. For example, a piecewise scheme and/or a bilinear scheme may be applied in a frequency domain to perform frequency warping.

The filter bank integration unit 307 may perform filter bank integration to extract the speech feature for speech recognition.

The log scaling unit 308 may calculate a log value of each speech feature value extracted by the filter bank integration unit 307.

The DCT unit 309 may perform a discrete cosine transform with on the calculated log value.

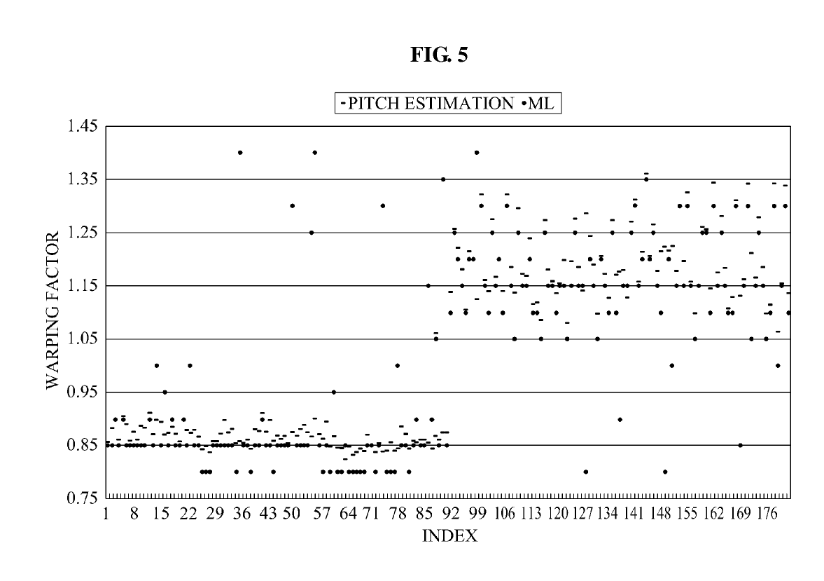

FIG. 5 illustrates warping factors of an example pitch estimation method and an example Maximum Likelihood (ML) method.

In the ML method, for example, speech recognition may be performed with respect to all available warping factors, and a warping factor with a greatest likelihood value may be selected. Using the ML method, an improved speech recognition result may be obtained. However, parallel processing for various cases should be performed and the number of operations required to perform such processing may be relatively great.

In the ML method, warping may be performed in various increments. In the example ML method of FIG. 5, warping is performed at 0.05 increments from a value of 0.8 to 1.4, and a warping factor with a greatest likelihood is illustrated. A correlation coefficient with the pitch estimation method may be approximately 0.81, which indicates a high correlation. The example illustrated in FIG. 5 is merely for purposes of example. It should be understood that various increments and ranges of warping may be performed.

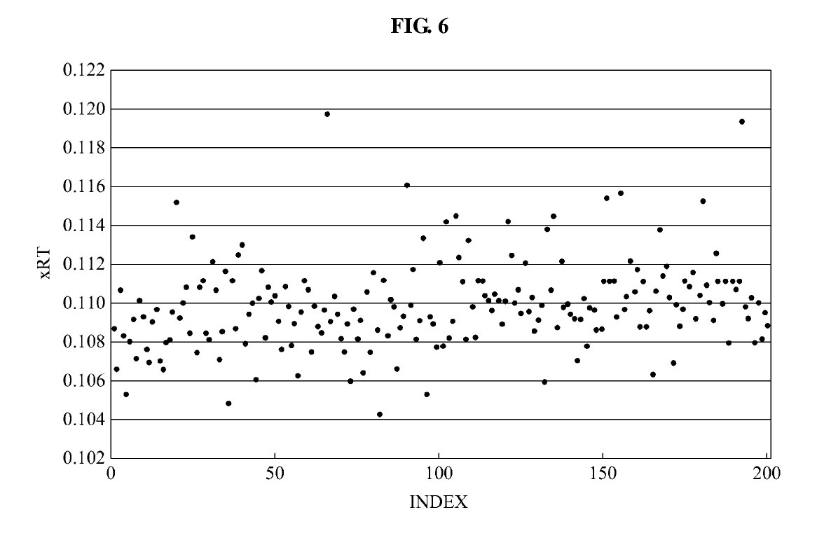

FIG. 6 illustrates an example of pitch estimation for 200 utterances.

In this example, FIG. 6 illustrates an example of estimating a pitch of 10 voice frames to reduce a pitch estimation time of a speech section. Although the pitch estimation time of an entire utterance is not very significant in the example of FIG. 5, the example speech recognition apparatus may be for real-time speaker adaptation, and thus, the pitch estimation time may need to be minimized to provide estimation in real time. In this example, the pitch is estimated with respect to the 10 voice frames in FIG. 6, however, this is merely for purposes of example, and it should be understood that a number of frames with respect to voice may be changed, based on how quickly the estimation result is desired.

Accordingly, the speech recognition apparatus may estimate the pitch in a voice frame, calculate a warping factor, and perform warping with respect to the corresponding voice frame. Also, when a speech section is an unvoiced frame, the speech recognition apparatus may calculate a warping factor based on a pitch of one or more previous voiced frames, and perform frequency warping.

The speech recognition apparatus may apply different warping factors to at least n voice frames, use an n^{th} frame value with respect to subsequent frames, and may reduce the pitch estimation time. In FIG. 6, although a 10^{th} frame value is applied to a last frame, an average value of ten frames may be applied to the last frame.

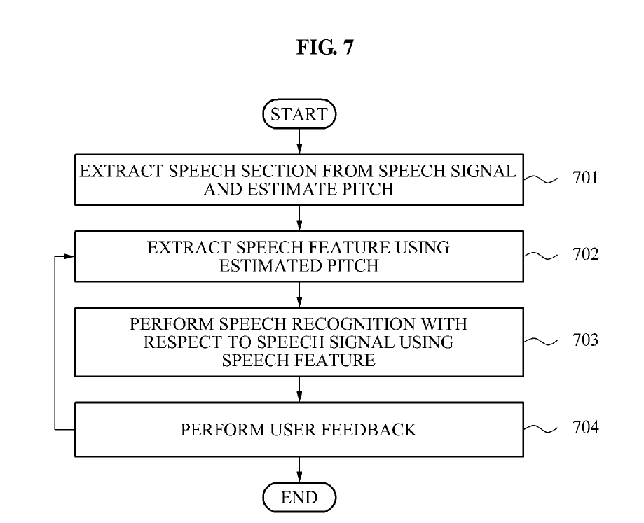

FIG. 7 illustrates an example speech recognition method.

Referring to FIG. 7, in operation 701, the speech recognition apparatus may extract a speech section from a speech signal and estimate a pitch of the speech section. For example, the speech recognition apparatus may extract the speech section that includes a starting point and an ending point of the speech section from the speech signal, and determine whether the speech section is a voice frame. In this example, when the speech section is a voice frame, the speech recognition apparatus may estimate the pitch of the speech section. Alternatively, when the speech section is an unvoiced frame, the speech recognition apparatus may replace the pitch of the speech section with the pitch of one or more previous voice frames.

In operation 702, the speech recognition apparatus may extract a speech feature for speech recognition from the speech section based on the estimated pitch. In this example, the speech recognition apparatus may calculate a warping factor for vocal tract length normalization based on the estimated pitch, and may perform frequency warping based on the warping factor. For example, before calculating the warping factor, the speech recognition apparatus may perform pre-processing to emphasize a high frequency band of the speech signal, and process a Hamming window with respect to the pre-processed speech signal.

In operation 703, the speech recognition apparatus may perform speech recognition with respect to the speech signal using the extracted speech feature.

In operation 704, the speech recognition apparatus may perform user feedback with respect to the speech recognition to improve an accuracy of the warping factor. In this example, the speech recognition apparatus may calculate the warping factor based on the user feedback. For example, the user feedback may include information about at least one of, the pitch, the warping factor, a speech recognition rate, and the like.

The descriptions of FIGS. 1 through 6 are also applicable to the method illustrated in FIG. 7. However, a further description of FIGS. 1 through 6 is omitted here for conciseness.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable laptop and/or tablet personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A speech recognition apparatus, comprising:
a pitch estimation unit configured to extract a speech section from a speech signal and to estimate a pitch of the speech section;
a speech feature extraction unit configured to extract a speech feature for speech recognition from the speech section based on the estimated pitch; and
a speech recognition unit configured to perform speech recognition with respect to the speech signal based on the extracted speech feature.

2. The speech recognition apparatus of claim 1, wherein the pitch estimation unit comprises:
a speech section extraction unit configured to extract the speech section, the speech section comprising a starting point and an ending point of the speech section; and
a voice determination unit configured to determine whether the speech section is a voice frame or an unvoiced frame.

3. The speech recognition apparatus of claim 2, wherein the pitch estimation unit is further configured to:
estimate the pitch of the speech section when the speech section is the voice frame; and
replace the pitch of the speech section with a pitch of one or more previous voice frames when the speech section is an unvoiced frame.

4. The speech recognition apparatus of claim 1, wherein the speech feature extraction unit comprises:
a warping factor calculation unit configured to calculate a warping factor for vocal tract length normalization based on the estimated pitch; and
a frequency warping unit configured to perform frequency warping based on the warping factor,
wherein the speech recognition unit is further configured to perform speech recognition based on the frequency-warped speech feature.

5. The speech recognition apparatus of claim 4, wherein the speech feature extraction unit further comprises:
a preprocessing unit configured to perform pre-processing to emphasize a high frequency band of the speech signal; and
a window processing unit configured to process a Hamming window with respect to the pre-processed speech signal,
wherein the warping factor calculation unit is further configured to calculate the warping factor with respect to the speech signal where the Hamming window is processed.

6. The speech recognition apparatus of claim 4, further comprising a user feedback unit configured to perform user feedback with respect to the speech recognition.

7. The speech recognition apparatus of claim 6, wherein the warping factor calculation unit is further configured to calculate the warping factor based on the user feedback.

8. The speech recognition apparatus of claim 6, wherein the user feedback comprises information about at least one of the pitch, the warping factor, and a speech recognition rate.

9. A speech recognition method, comprising:
extracting a speech section from a speech signal and estimating a pitch of the speech section;
extracting a speech feature for speech recognition in the speech section based on the estimated pitch; and
performing speech recognition with respect to the speech signal based on the extracted speech feature.

10. The speech recognition method of claim 9, further comprising performing user feedback with respect to the speech recognition to increase an accuracy of a warping factor.

11. A voice recognition apparatus, comprising:
a pitch estimation unit configured to detect a pitch of a voice frame generated by a voice;
a voice feature extraction unit configured to extract a voice feature from the detected pitch of the voice frame; and
a voice recognition unit configured to perform voice recognition from the extracted voice feature.

12. The voice recognition apparatus of claim 11, wherein the pitch estimation unit comprises:
a voice frame extraction unit configured to extract, from the voice a starting point and an ending point of the voice frame; and
a voice determination unit configured to determine whether the speech section is a voice frame or an unvoiced frame.

13. The voice recognition apparatus of claim 11, wherein, if the voice frame is an unvoiced frame, the pitch estimation unit is further configured to replace the pitch of the unvoiced frame with a pitch of one or more previous voice frames.

14. The voice recognition apparatus of claim 11, wherein the voice feature extraction unit comprises:
a warping factor calculation unit configured to calculate a warping factor for vocal tract length normalization based on the detected pitch; and
a frequency warping unit configured to perform frequency warping based on the warping factor,
wherein the voice recognition unit is further configured to perform voice recognition based on the frequency-warped speech feature.

15. The voice recognition apparatus of claim 11, wherein the voice frame comprises at least one of: a spoken word, a spoken sentence, and a spoken utterance.
